(19) United States
(12) Patent Application Publication
(10) Pub. No.: US 2023/0207834 A1
(43) Pub. Date: Jun. 29, 2023

(54) GAS DIFFUSION LAYER STRUCTURE FOR FUEL CELL

(71) Applicants: HYUNDAI MOTOR COMPANY, Seoul (KR); KIA CORPORATION, Seoul (KR)

(72) Inventor: Sung Ho Lee, Yongin-si (KR)

(73) Assignees: Hyundai Motor Company, Seoul (KR); KIa Corporation, Seoul (KR)

(21) Appl. No.: 17/989,185

(22) Filed: Nov. 17, 2022

(30) Foreign Application Priority Data
Dec. 23, 2021 (KR) 10-2021-0185619

(51) Int. Cl. H01M 4/88; H01M 8/1062; H01M 8/0245

(52) U.S. Cl. CPC H01M 4/8807; H01M 8/1062; H01M 8/0245

(57) ABSTRACT

The present disclosure relates to a gas diffusion layer structure for a unit cell of a fuel cell, the gas diffusion layer structure includes a gas diffusion layer disposed between a catalyst layer and a separator of the unit cell of the fuel cell, in which the gas diffusion layer includes a microporous layer positioned adjacent to the catalyst layer, and a base layer positioned between the microporous layer and the separator, in which the base layer includes: a microporous layer adjacent region disposed adjacent to the microporous layer, and a gas channel adjacent region disposed adjacent to the separator, and in which the gas diffusion layer is pressed so that a solid volume fraction of the gas channel adjacent region and the microporous layer adjacent region increases to a target solid volume fraction.

This application claims under 35 U.S.C. § 119(a) the benefit of Korean Patent Application No. 10-2021-0185619 filed on Dec. 23, 2021 in the Korean Intellectual Property Office, the entire contents of which are incorporated herein by reference.

### TECHNICAL FIELD

The present disclosure relates to a fuel cell, and more particularly, to a structure of two opposite ends of a base layer based on a thickness direction of the base layer that corresponds to an external force applied to a gas diffusion layer included in a unit cell of a fuel cell.

### BACKGROUND

A unit cell of a fuel cell includes: a polymer electrolyte membrane; an air electrode (cathode) and a fuel electrode (anode), which are electrode catalyst layers, applied to two opposite surfaces of the electrolyte membrane so that hydrogen and oxygen react; gas diffusion layers (GDL) stacked on outer portions on which the air electrode and the fuel electrode are positioned; and separators stacked on outer portions of the gas diffusion layers and configured to supply fuel and discharge water produced by the reaction.

The gas diffusion layer (GDL) supports the air electrode and the fuel electrode, which are catalyst layers, and includes a carbon base and a microporous layer (MPL). The gas diffusion layer (GDL) serves to (a) transmit reactant gas to the catalyst layer so that the reactant gas is evenly distributed on the catalyst layer, (b) discharge produced water produced by the electrochemical reaction in the catalyst layer, and (c) transfer electricity and heat generated in the catalyst layer.

When the pore of the gas diffusion layer (GDL) increases in size, the diffusion of gas is improved, but heat and electricity conduction routes are reduced, which increases thermal and electrical resistance. On the contrary, when the conduction route in the gas diffusion layer (GDL) is increased to improve the thermal and electrical conductivity, the pore decreases in size.

However, because the base layer of the gas diffusion layer is made by stacking carbon fibers, the gas diffusion layer does not have a uniform density in a thickness direction. For this reason, density of a region adjacent to two opposite ends based on the thickness direction decreases, and the base layer and the microporous layer are separated or damaged because of an external force.

### DOCUMENT OF RELATED ART

### Patent Document

Patent Application Laid-Open No. 10-2020-0031845 (published on Mar. 25, 2020)

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with prior art.

An object of the present disclosure is to provide a gas diffusion layer structure for a fuel cell, which is capable of increasing a solid volume fraction (SVF) of a base layer at a corresponding position in response to stress generated between the base layer and a microporous layer.

When the microporous layer is applied as a condition for restricting the base layer, a relative displacement may occur between the base layer and the microporous layer, and the gas diffusion layer structure may be deformed. Therefore, another object of the present disclosure is to provide a coupling relationship between a base layer and a microporous layer in order to avoid distortion of a function of an initial structure state.

Still another object of the present disclosure is to provide a gas diffusion layer structure for a fuel cell, which is capable of forming a required solid volume fraction (SVF) of a base layer by providing a pore layer for pressing the base layer.

The objects of the present disclosure are not limited to the above-mentioned objects, and other objects of the present disclosure, which are not mentioned above, may be understood from the following descriptions and more clearly understood from the embodiment of the present disclosure. In addition, the objects of the present disclosure may be realized by means defined in the claims and a combination thereof.

To achieve the above-mentioned objects of the present disclosure, the gas diffusion layer structure for a fuel cell includes the following configurations.

In one aspect, the present disclosure provides a gas diffusion layer structure for a unit cell of a fuel cell, in which a gas diffusion layer disposed between a catalyst layer and a separator of the unit cell of the fuel cell, includes: a microporous layer positioned adjacent to the catalyst layer; and a base layer positioned between the microporous layer and the separator, in which the base layer includes: a microporous layer adjacent region disposed adjacent to the microporous layer; and a gas channel adjacent region disposed adjacent to the separator, and in which the gas diffusion layer is pressed so that a solid volume fraction of the gas channel adjacent region and the microporous layer adjacent region increases to a target solid volume fraction.

In a preferred embodiment, in a structural change of the gas diffusion layer, the base layer is compressed, and then resin impregnation or slurry coating is performed.

In another preferred embodiment, a compressive force for performing compression of the base layer is set to have a thickness of 70% to 95% of an initial thickness of the base layer.

In still another preferred embodiment, a structural change of the gas diffusion layer may further include a pore layer configured to additionally press the base layer after compression of the base layer.

In yet another preferred embodiment, the base layer may be pressed by the pore layer, and the base layer may be impregnated with the pore layer.

In still yet another preferred embodiment, the microporous layer may be applied onto an upper surface of the base layer from which the pore layer is removed.

In a further preferred embodiment, the predetermined fraction may be set based on an external force applied to the base layer.

In another aspect, the present disclosure provides a method of manufacturing a gas diffusion layer for a unit cell of a fuel cell, the method including: forming a base layer; pressing, by a pore layer, two opposite surfaces of the base layer; impregnating the base layer with a resin mixture; performing heat treatment and waterproof treatment; and coating the base layer with a microporous layer.

In a preferred embodiment, the coating of the base layer with the microporous layer may further include: pressing again, by the pore layer, one surface of the base layer to be coated with the microporous layer; and performing slurry coating on the one surface of the base layer pressed again by the pore layer.

In another preferred embodiment, the performing of the slurry coating on the one surface of the base layer pressed again by the pore layer may further include: removing the pore layer after the slurry adheres to the base layer; and performing additional slurry coating on a region of the base layer from which the pore layer is removed.

The present disclosure may obtain the following effects from the above-mentioned present embodiment and configurations, engagements, and usage relationships to be described below.

According to the present disclosure, it is possible to provide the gas diffusion layer structure for a fuel cell, which is capable of preventing damage by improving the solid volume fraction (SVF) of the base layer facing the microporous layer and the separator.

In addition, according to the present disclosure, it is possible to increase durability of the gas diffusion layer of the fuel cell by improving the solid volume fraction (SVF) of the base layer.

Other aspects and preferred embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a cross-sectional view of a unit cell of a fuel cell according to an embodiment of the present disclosure;

FIG. 2 is a view illustrating configurations of a base layer and a microporous layer that constitute a gas diffusion layer according to the embodiment of the present disclosure;

FIG. 3 is a view illustrating a solid volume fraction according to a thickness of the base layer according to the embodiment of the present disclosure before the base layer is pressed; and

FIG. 4 is a view illustrating a solid volume fraction according to a thickness of the pressed base layer according to the embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

Hereinafter, embodiments of the present disclosure will be described in more detail with reference to the accompanying drawings. The embodiments of the present disclosure may be modified in various different forms, and it is not interpreted that the scope of the present disclosure is limited to the following embodiments. The present embodiments are provided to more completely explain the present disclosure to those skilled in the art.

In addition, the term “layer”, “membrane”, “electrode”, or the like, which is described in the specification, means a unit that performs at least one function or operation, and the “unit”, “part”, or the like may be implemented by hardware, software, or a combination of hardware and software.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements. Other expressions, that is, “between” and “just between” or “adjacent to” and “directly adjacent to”, for explaining a relationship between constituent elements, should be interpreted in a similar manner.

In addition, the terms used in the present specification are used only for the purpose of describing particular embodiments and are not intended to limit the embodiments. Singular expressions include plural expressions unless clearly described as different meanings in the context.

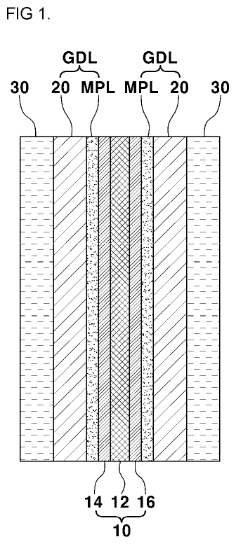

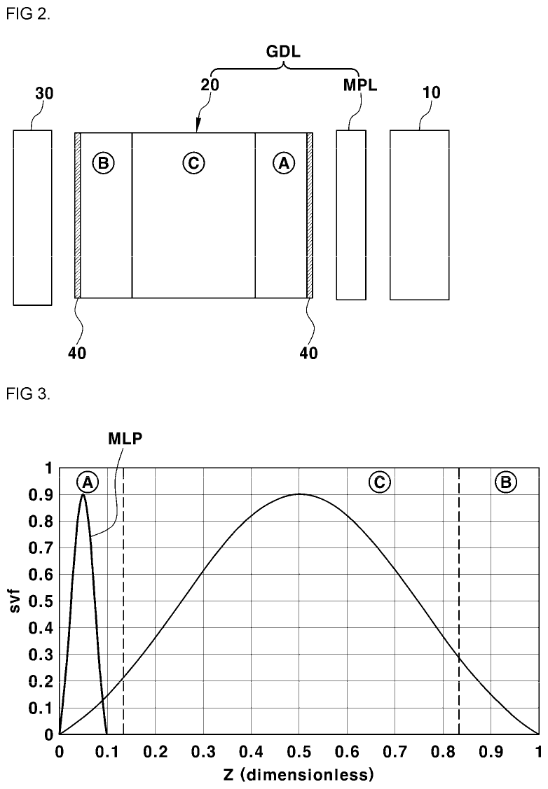

As illustrated in FIGS. 1 to 2, a unit cell of a fuel cell includes a membrane electrode assembly 10. The membrane electrode assembly 10 includes a polymer electrolyte membrane 12 configured to move hydrogen cations, and an air electrode 14 (cathode) and a fuel electrode 16 (anode) which are catalyst layers applied to two opposite surfaces of the electrolyte membrane 12 so that hydrogen and oxygen react.

Gas diffusion layers (GDLs) are stacked on outer sides of the membrane electrode assembly 10, i.e., an outer side of the air electrode 14 and an outer side of the fuel electrode 16. A separator 30 is disposed on an outer side of the gas diffusion layer (GDL) and includes flow paths through which fuel is supplied and water produced by the reaction is discharged.

The gas diffusion layer (GDL) includes a base layer 20 including carbon fibers, and a microporous layer (MPL) provided at one side of the base layer 20.

In general, the base layer 20 includes carbon fibers and hydrophobic substances. As a non-restrictive example, carbon fiber cloth, carbon fiber felt, and carbon fiber paper may be used as the base layer 20.

The microporous layer (MPL) may be manufactured by mixing the hydrophobic substances with carbon powder such as carbon black and applied onto one surface of the base layer 20 depending on the use thereof.

The base layer 20 is manufactured through the following steps. The steps include a step of fiberizing a polymer and a step of stabilizing the polymer at 230° C. to prevent rapid chemical decomposition in an oxygen ambience before the polymer is carbonized. Thereafter, the process of carbonizing the polymer includes a step of forming independent filaments from carbon fibers by using epoxy resin. Thereafter, a step of cutting the carbon fiber into a predetermined length (3 to 12 mm) and forming raw paper by spraying water to the carbon fiber by using a polymeric binder and a surfactant is performed. Thereafter, a step of primarily binding the paper carbon fibers through a heat treatment process and impregnating precursors for binding the carbon fibers and inorganic filler-mixed resin with the paper carbon fibers is performed. The method includes a step of pressing two opposite surfaces of the base layer by using a pore layer (mesh plate) 40 after the step of primarily binding the carbon fibers and before the step of impregnating the resin mixture. Thereafter, the method includes a step of impregnating the base layer 20 with the resin mixture and performing heat treatment and waterproof treatment. As the base layer is pressed by the pore layer, a solid volume fraction of the base layer increases to a target solid volume fraction.

As the step of performing the heat treatment and waterproof treatment, a step of carbonizing the precursor by performing high-temperature heat treatment (1,200 to 1,400° C.) and a step of improving mechanical strength by performing higher-temperature heat treatment (2,000 to 2,400° C.) are performed. Thereafter, the method includes a step of increasing water-repellent power by impregnating the carbon fiber paper with a Teflon waterproof liquid.

The carbon fiber paper is coated with the microporous layer by using slurry containing carbon powder and Teflon on the manufactured base layer 20. After the microporous layer is applied, the gas diffusion layer is manufactured by a step of improving Teflon dispersibility by performing heat treatment at a temperature equal to or higher than a melting point (to 350° C.) of Teflon.

Moreover, the present disclosure may include a process of pressing the carbon fibers after the step of primarily binding the paper carbon fibers through the heat treatment process is performed. In more particular, in the embodiment of the present disclosure, a range of a pressure applied in the step of pressing the paper carbon fibers may be set so as to have a thickness of 70% to 95% of an initial thickness of the base layer 20.

In addition, as described above with reference to the manufacturing method, the step of manufacturing the base layer 20 is performed, and the step of impregnating the manufactured base layer 20 and the microporous layer is performed. In more particular, the method includes a step of pressing the base layer 20 to be coated with the microporous layer by the pore layer 40 before one surface of the base layer 20 is coated with the microporous layer. Therefore, the base layer 20 is pressed to have a preset thickness, and slurry coating is performed to form the microporous layer on the one surface of the pressed base layer 20. After the slurry adheres to the base layer 20, the pore layer 40 may be removed. The method includes a step of performing additional slurry coating in a partial region of the base layer 20 from which the pore layer 40 is removed.

After the base layer 20 of the gas diffusion layer (GDL) is manufactured, the microporous layer (MPL) is provided. Moreover, the density of the base layer 20 is decreased by staking the carbon fibers at the initial time of forming the base layer 200. As the carbon fibers having a predetermined length are accumulated, the situation in which the density of the base layer 20 is decreased necessarily occurs at a point in time at which the number of carbon fibers to be added decreases from the latter part of the stacking process to the end point in time and the decrease in number of carbon fibers is completed, i.e., the number of carbon fibers is 0. According to some embodiments of the present disclosure, the solid volume fraction (SVF) is increased by additionally injecting the binder after the gas diffusion layer (GDL) is formed or in the step of forming the base layer 20. That is, the binder is additionally injected after both the microporous layer (MPL) and the base layer 20 are formed.

According to some embodiments of the present disclosure, the solid volume fraction (SVF) is increased by additionally adding the carbon fibers in the latter part of the process of stacking the carbon fibers during the process of manufacturing the base layer 20 in comparison with the related art. That is, the carbon fibers are stacked after the amounts of carbon fiber or binder to be added are set in advance on the basis of porosity and/or the solid volume fraction (SVF) intended to be obtained in the gas channel adjacent region. According to some embodiments of the present disclosure, the two embodiments are combined. That is, the process of additionally injecting the binder and the process of additionally adding the carbon fiber are simultaneously performed during the process of manufacturing the gas diffusion layer (GDL). However, as described above, the region for increasing the solid volume fraction (SVF) by means of the carbon fiber and/or the binder on the base layer 20 is applied to the gas channel adjacent region, and the region is not applied to the microporous layer adjacent region of the base layer 20.

In the embodiment of the present disclosure, as a component for pressing the base layer 20, the pore layer 40 may be provided and configured to press the paper carbon fibers. Moreover, the pore layer 40 may be configured to press the base layer 20 again after the step of performing the waterproof treatment.

The pore layer 40 includes a plurality of pores positioned on the two opposite surfaces of the base layer 20 based on the thickness direction of the base layer 20. The pore layer 40 may be configured to apply a predetermined pressure in a direction in which a thickness of the base layer 20 decreases. Moreover, the pores of the pore layer 40 for pressing the paper carbon fibers may be impregnated with the resin mixture, and the resin mixture adheres. However, the pore layer 40 may be removed from the base layer 20 according to the process after the impregnation.

Moreover, the base layer 20 may be positioned by being impregnated with the pore layer 40, and the pore layer 40 may be removed from the base layer 20 before the microporous layer is applied. The microporous layer may be positioned, by additional coating, on the upper surface of the base layer 20 from which the pore layer 40 is removed.

FIG. 3 illustrates a change in solid volume fraction (SVF) according to positions on the gas diffusion layer (GDL) in the thickness direction. The x-axis indicates positions in the thickness direction on the cross-section illustrated in FIG. 2 from the microporous layer to the separator. FIG. 3 illustrates an example in which the thickness at the catalyst layer side is 0, and the thickness increases toward the right side.

As illustrated in FIG. 3, the base layer 20 may be divided into approximately three regions in consideration of the solid volume fraction according to the positions of the base layer 20 in the thickness direction. The three regions will be referred to as a microporous layer adjacent region A, a central portion region C of the base layer 20, and a gas channel adjacent region B. The microporous layer adjacent region A is positioned as the microporous layer (MPL) is applied onto the upper surface of the base layer 20, and the microporous layer adjacent region A is disposed adjacent to the air electrode 14 or the fuel electrode 16, which is the catalyst layer, with the microporous layer interposed therebetween. The central portion region C of the base layer 20 is a central portion of the base layer 20 as the name of the central portion region C shows. The gas channel adjacent region B is disposed adjacent to a gas channel formed in the separator 30.

The solid volume fraction (SVF) is high in the central portion region C of the base layer 20. The solid volume fraction (SVF) in a portion of the microporous layer adjacent region A very close to a boundary with the catalyst layer and the solid volume fraction (SVF) in the gas channel adjacent region B have a smaller value than the solid volume fraction (SVF) in the central portion region C. That is, in view of density, the density decreases toward the two opposite ends based on the central portion region of the base layer 20, and this means that the central portion region of the base layer 20 acts as a region vulnerable to stress.

In addition, in the microporous layer adjacent region A, the microporous layer and the base layer 20 are positioned to be restricted by each other, such that torsional moment of force may occur about the microporous layer in the region A adjacent to the base layer 20.

That is, a shearing force is generated, at a position at which the base layer 20 is adjacent to the microporous layer, by an external force generated in the unit cell, and bending moment of force of a cantilevered beam is generated at a position at which the base layer 20 and the microporous layer adjoin each other from a position at which the separator 30 and the base layer 20 are fastened. For this reason, there is a problem in that structural deformation occurs.

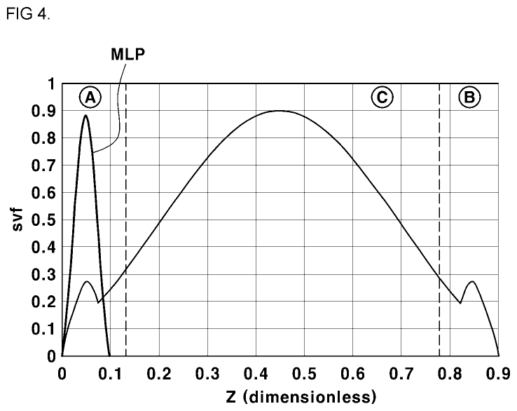

FIG. 4 illustrates a change in solid volume fraction (SVF) in the thickness direction of the base layer 20 when the base layer 20 is pressed.

The embodiment of the present disclosure shows the change in solid volume fraction (SVF) according to the positions in the thickness direction of the base layer 20 when the base layer 20 is pressed. The solid volume fraction at the two opposite ends of the base layer 20 is relatively higher than the solid volume fraction illustrated in FIG. 3.

That is, to form the base layer 20 according to the present disclosure, the step of primarily binding the paper carbon fibers is performed, and then the process of pressing the carbon fibers is performed, such that the thickness of the base layer 20 is decreased, and the solid volume fraction at the two opposite ends in the thickness direction is increased. In addition, a thickness of a width of the compressed base layer 20 is 75% to 95% of a thickness of a width illustrated in FIG. 3. That is, the initially manufactured base layer 20 is pressed so that the solid volume fraction in the gas channel adjacent region or the microporous layer adjacent region is greater than or equal to a predetermined fraction. In this case, the predetermined fraction means a fraction equal to the preset target solid volume fraction.

Moreover, the embodiment of the present disclosure includes the pore layer as a component for pressing the base layer 20, and the pore layer may be configured to press the paper carbon fibers or press the two opposite ends of the base layer 20 on which the waterproof treatment has been completely performed.

Moreover, as the amount of base layer 20 impregnated in the microporous layer is increased, the base layer of the microporous layer adjacent region A, a contact area between the microporous layer and the base layer 20 increases, and a mutual fastening force increases. In addition, a supporting force between the base layer 20 and the microporous layer is increased by the increased fastening force when torsion is generated by the external force.

In more particular, the pore layer 40 is formed between the base layer 20 and the microporous layer so that the base layer 20 and the microporous layer are impregnated, such that the base layer 20 and the microporous layer are impregnated and adhered on the basis of the pore layer 40.

Therefore, it is possible to increase the supporting force against the rotational moment of force generated from the external force applied to the cell between the facing surfaces of the microporous layer and the base layer 20 or between the regions impregnated and superimposed.

The thickness of the pressed base layer 20 according to the embodiment of the present disclosure has 90% of a thickness of the base layer 20 which is not pressed. Moreover, it can be seen that the solid volume fraction at the position positioned by 10% from the two opposite ends of the pressed base layer 20 based on the thickness direction has a value increased by 1.5 to 1.8 times.

That is, the base layer 20 has a reduced thickness by being pressed, and the solid volume fraction at the point positioned by 10% from the two opposite ends of the base layer 20 based on the thickness direction increases, such that it is possible to minimize deformation between the microporous layers applied onto the base layer 20.

The foregoing detailed description illustrates the present disclosure. Further, the foregoing description merely shows and describes the exemplary embodiments of the present disclosure, and the present disclosure can be used in various other combinations, modifications, and environments. That is, alterations or modifications may be made within the scope of the concept of the disclosure disclosed in the present specification, the scope equivalent to the described disclosure, and/or the scope of the technology or knowledge in the art. The disclosed embodiments are provided to explain the best state for implementing the technical spirit the present disclosure, and various modifications required for the specific fields of application and the use of the present disclosure may be made. Thus, the detailed description of the present disclosure is not intended to limit the present disclosure to the disclosed embodiments. Moreover, the appended claims should be construed to include other embodiments.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A gas diffusion layer structure for a unit cell of a fuel cell, in which a gas diffusion layer disposed between a catalyst layer and a separator of the unit cell of the fuel cell, comprising:
a microporous layer positioned adjacent to the catalyst layer; and
a base layer positioned between the microporous layer and the separator, wherein the base layer comprises:
a microporous layer adjacent region disposed adjacent to the microporous layer; and
a gas channel adjacent region disposed adjacent to the separator, and
wherein a solid volume fraction of the gas channel adjacent region or the microporous layer adjacent region is greater than or equal to a predetermined fraction.

2. The gas diffusion layer structure of claim 1, wherein in a structural change of the gas diffusion layer, the base layer is compressed, and then resin impregnation or slurry coating is performed.

3. The gas diffusion layer structure of claim 2, wherein a compressive force for performing compression of the base layer is set to have a thickness of 70% to 95% of an initial thickness of the base layer.

4. The gas diffusion layer structure of claim 1, wherein a structural change of the gas diffusion layer further comprises a pore layer configured to additionally press the base layer after compression of the base layer.

5. The gas diffusion layer structure of claim 4, wherein the base layer is pressed by the pore layer, and the base layer is impregnated with the pore layer.

6. The gas diffusion layer structure of claim 4, wherein the microporous layer is applied onto an upper surface of the base layer from which the pore layer is removed.

7. The gas diffusion layer structure of claim 1, wherein the predetermined fraction is set based on an external force applied to the base layer.

8. The gas diffusion layer structure of claim 1, wherein the base layer further comprises a binder or a carbon fiber.

9. A method of manufacturing a gas diffusion layer for a unit cell of a fuel cell, the method comprising:
forming a base layer;
pressing, by a pore layer, the base layer so that a solid volume fraction of the base layer increases to a target solid volume fraction;
impregnating the base layer with a resin mixture;
performing heat treatment and waterproof treatment; and
coating the base layer with a microporous layer.

10. The method of claim 9, wherein the coating of the base layer with the microporous layer further comprises:
pressing again, by the pore layer, one surface of the base layer to be coated with the microporous layer; and
performing slurry coating on the one surface of the base layer pressed again by the pore layer.

11. The method of claim 10, wherein the performing of the slurry coating on the one surface of the base layer pressed again by the pore layer further comprises:
removing the pore layer after the slurry adheres to the base layer; and
performing additional slurry coating on a region of the base layer from which the pore layer is removed.

12. The method of claim 9, wherein the forming of the base layer further comprises adding a binder or carbon fiber.

13. The method of claim 9, wherein a thickness of the base layer pressed by the pore layer is 70% to 95% of an initial thickness of the base layer.
